(19) United States
(12) Patent Application Publication
(10) Pub. No.: US 2014/0249866 A1
(43) Pub. Date: Sep. 4, 2014

(54) QUEUE MANAGEMENT SYSTEM AND METHOD

(71) Applicants: Robert Popkey, Long Grove, IL (US); Michael Rzeznik, Lake Zurich, IL (US)

(72) Inventors: Robert Popkey, Long Grove, IL (US); Michael Rzeznik, Lake Zurich, IL (US)

(21) Appl. No.: 13/783,441

(22) Filed: Mar. 4, 2013

(51) Int. Cl. G06Q 10/02

(52) U.S. Cl. CPC G06Q 10/02
USPC 705/5

(57) ABSTRACT

An automated waiting line transaction management system that provides patrons/users the option of queuing up and waiting in the standard attraction line at a venue or obtaining an ID unit that can be used for purchasing a pass to bypass the normal line. The venue administrator sets pass prices for each attraction on a real time basis either manually or through a venue algorithm.

### CROSS-REFERENCE TO RELATED APPLICATION

This application claims the benefit of priority under USC §119(e) of provisional application No. 61/696,336, filed Sep. 4, 2012 entitled “Amusement Park Wristband Transaction System”, hereby incorporated by reference herein.

### BACKGROUND OF THE INVENTION

I. Field of the Invention

The present disclosure relates generally to managing access to products and services at a location generally having a queue of patrons. In particular, the present disclosure is directed to systems, methods, and apparatuses for managing the transactions enabling a customer to bypass the ordinary waiting line at an amusement park attraction, a ski resort lift, concert or sporting events, and the like.

II. Description of the Prior Art

There are a number of circumstances where people have to wait in line in order to do something. At restaurants, for example, whether the customer has made a reservation or not, they often need to wait in line for the next available table to open up. Other situations where people have to wait in line include gaining admission to clubs, buying tickets for sporting events and concerts, gaining admission into amusement parks and waiting for particular attractions therein, gaining admission to museums and other tourist attractions, checkout lines at stores, airport security, etc. Basically, a line forms any place where the number of people arriving to take advantage of goods or services at any one time exceeds the speed at which any one customer or group of customers can be served.

Whether it is the customer waiting in the line or the merchant needing to form the line, these circumstances create sacrifice. As to the customer, the time spent in line, and thus the sacrifice, is typically wasted time. If possible, the customer would much rather come back later when there is no line so that he can do other things instead of waiting in line. For example, in the amusement park setting, there may be hundreds of rides, shows, shops, games, parades, displays, and food services. If a customer has to wait in line for each attraction, the customer may be able to utilize only a small number of attractions in any particular visit. Not only is the customer frustrated at not being able to access more attractions, but the customer is frustrated for having paid for an admission to attractions not used. Another example from the customer side is where a professional needs to entertain a client with a dinner and/or at a nightclub. Whether reservations have been made or not, there are times when the arriving group needs to wait in line for the next available table at the restaurant or club. While the client obviously does not want to wait in a line, this type of situation may turn out to be particularly risky for the professional.

Turning to the merchant side, it is the lost revenue that is the sacrifice. Referring back to the amusement park example, assuming that customers spend at least 50% of their time in the park standing in a waiting line for different attractions; that means that at least 50% of the time the customers are not able to make purchases of merchandise, food and beverages, etc. As a result, the theme park loses significant potential income opportunities because their customers are spending too much time waiting in lines. Similarly, referring back to the restaurant or club example, rather than risk upsetting and possibly losing the client due to a long wait, the professional would probably rather entertain his client at an establishment without a wait. Therefore, the merchant loses the business.

No matter how the line forms or what type of parties are involved, time is wasted. Life is too short to be spending it in a waiting line. While time has always been associated with money, it has never been as true as it is now during the fast pace of life today. As consumers experience a greater squeeze on their time, short waits seem longer than ever before. The changing demographics of the last decade have made time more valuable now than the past. People work longer and more varied hours, and due to stagnating wages and a drastic unemployment shift, many are forced to work overtime or hold second jobs to maintain their lifestyle. This has resulted in weekly U.S. leisure time declining from 26.2 hours to 16.6 hours. Accordingly, such pressures have shifted consumers values placing greater value on their free time.

The amusement park environment has seen numerous attempts to address the mutual sacrifices of both customer and merchant that are inherent in the long waiting lines associated with many of the attractions at the park. The most common attempt is the system that allows the customer to reserve a window in time to enjoy an attraction. For example, at 1:30 pm the customer wants to ride Roller Coaster X but there is a 90 minute wait posted outside the standby line. Rather than wait in the standby line, the customer obtains a reservation (in the form of a paper printout, virtual medium, or otherwise) with a return time of 4:00 to 5:00 pm, for example. He then has 2½ hours to enjoy other attractions before returning to Roller Coaster X, bypassing the standby line, and enjoying the ride with little or no wait. While the customer is free to use the intermediate time as he desires, in order to access the ride at the appropriate time, he will still need to allocate his time accordingly. Meanwhile, while the amusement park may receive an additional purchase from the customer, it is by no means an optimal arrangement.

Another attempt in the amusement park environment is some type of virtual wait daily pass. This pass will basically hold the position of the bearer in line electronically. Depending upon the price spent on such a pass, the customer may virtually wait as long as everyone else in the line is physically waiting, or may wait less, or even not at all. For example, the customer visits the attraction, and his pass is activated such that he is virtually waiting in line but can physically be visiting other attractions. When it is his turn, an alert is sent to the pass and he can then return and enjoy the attraction. Once again, while the customer can use the intermediate time as he desires, he still must be ready to attend the attraction he is virtually waiting in line for when the pass receives the alert. Otherwise he will miss his opportunity to enjoy the attraction. Additionally, while the park may receive some increased revenue from both the initial purchase of the daily pass and any intermediate purchases, such Passes are not utilized by the masses, and this revenue is not optimized.

In order to employ one of the current attempts to address the problems at amusement parks, the parks have spent considerable time, energy and finances to create separate areas for those patrons utilizing the s-called ‘window in time’ and/or ‘virtual wait’ pass. Specifically, those attractions that create the longest lines now typically have additional space which has been designed to accommodate this separate pass line. Unfortunately, as these areas are not utilized to their potential, the costs associated with their construction, implementation and maintenance has been lost.

Accordingly, it is a general object of this disclosure to provide systems, methods and apparatuses for addressing the deficiencies of the current practices regarding issues associated with waiting lines at amusement parks and the like.

It is another general object of this disclosure to provide systems, methods and apparatuses for managing the transactions enabling a customer to bypass the ordinary waiting line at an amusement park attraction.

It is more specific object of this disclosure to provide systems, methods and apparatuses for decreasing the amount of time wasted waiting in a line at an amusement park attraction.

It is another more specific object of this disclosure to provide systems, methods and apparatuses for optimizing amusement park revenue from customers who do not want to wait in line.

It is yet another specific object of this disclosure to provide systems, methods and apparatuses for utilizing existing additional attraction queuing space at amusement parks.

These and other objects, features and advantages of this disclosure will be clearly understood through a consideration of the following detailed description.

### SUMMARY OF THE INVENTION

According to an embodiment of the present invention, there is provided an attraction waiting line management system for use with personal identification units having monetary credit including a first queue where users wait in line to access the attraction and a second queue where users bypass the first queue to gain access. A venue communication device establishes a price, through a network, for the user to purchase a pass for the second queue; and an identification unit reader deducts the price from the credit to permit access.

There is also provided an automated system for managing waiting time at an attraction for use with personal identification units having monetary credit associated therewith. A venue communication device communicates through a network and establishes a price for a user to purchase a priority access to an attraction; and an identification reader deducts the price from the credit of the unit and permits access.

There is also provided an automated system for managing waiting time at an attraction within a venue for use with personal identification units having monetary credit associated therewith. A personal identification database and an attractions database, both databases in communication with a server. The server in communication with a venue communication device that establishes a price for priority access to an attraction; and an identification unit reader at each attraction that deducts the price from the credit of the unit and permits priority access.

There is further provided a venue waiting line management system for use with one or more attractions and venue specific personal identification units having monetary credit associated therewith. The system includes a first queue where patrons access an attraction by waiting in line and a second queue where patrons bypass the first queue and gain access. A venue communication device establishes a price, through a network, for a patron to purchase a pass for access to the second queue; and an attraction identification unit reader that deducts the price from the credit of the unit and permits access to the second queue.

There is further provided an admission management system including an attraction, a first queue to gain access to the attraction through waiting in line and a second queue enabling a bypass of the first queue. A personal identification unit having negotiable credits associated therewith, a unit reader capable of recognizing the unit code and capable of modifying the number of credits associated therewith. An attraction communication device communicating with the reader to establish a number of negotiable credits for access to the second queue whereby the reader and the unit allow access to the second queue by subtracting the number of credits.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is illustrative of a communication network environment in which preferred embodiments of the waiting line transaction management system of the present disclosure are implemented.

FIG. 2 is a patron purchase ID flow diagram for the waiting line transaction management system of the present disclosure.

FIG. 3 is a patron administration process for the waiting line transaction management system of the present disclosure.

FIG. 4 is a personal communication device (PCD) screen shot illustrating patron options upon log in.

FIG. 5 is a PCD screen shot illustrating a listing of venue attractions.

FIG. 6 is a PCD screen shot illustrating a venue map.

FIG. 7a is a PCD screen shot illustrating a venue map with an attraction selected.

FIG. 7b is a PCD screen shot illustrating a venue map with an attraction selected.

FIG. 8a is a PCD screen shot illustrating an attraction detail.

FIG. 8b is a PCD screen shot illustrating an attraction detail.

FIG. 9 is a PCD screen shot illustrating patron administration.

FIG. 10 is a PCD screen shot illustrating patron ID activation.

FIG. 11 is a PCD screen shot illustrating an ID detail.

FIG. 12 is a PCD screen shot illustrating patron crediting of an ID.

FIG. 13 is an ID flow diagram for use at an attraction utilizing the waiting line transaction management system of the present disclosure.

FIG. 14 is a business administration process flow diagram for use of the waiting line transaction management system of the present disclosure.

FIG. 15 is a PCD screen shot illustrating business administration options upon log in.

FIG. 16 is a PCD screen shot illustrating business administration ID activation.

FIG. 17a is a PCD screen shot illustrating business administration attraction detail.

FIG. 17b is a PCD screen shot illustrating business administration attraction detail upon ID acceptance.

FIG. 18 is a PCD screen shot illustrating business administration message sending.

### DESCRIPTION OF THE PREFERRED EMBODIMENTS

The following description of the preferred embodiments is merely exemplary in nature and is in no way intended to limit the disclosure, its application or use. For example, the venues as discussed herein (i.e. amusement parks and/or ski resorts) are not to be limited thereto as it is envisioned that the concept could be also used for waterparks, restaurants, festivals, concerts, traveling individuals, spring break packages, group excursions, vacations, sporting events, etc. Similarly, the user identifications can be for both public and private use and those discussed herein (i.e. radio-frequency identification bracelets or RFID bracelets) are not to be limited thereto. For example, an RFID subset, the so-called Near Field Communication (or NFC) protocol may also be utilized. As is known, NFC allows for two-way communication and a more limited range than RFID. These exemplars are merely used to better describe the true spirit and scope of the present disclosure.

The present queue and/or admission management system allows patrons at a venue to skip lines and/or purchase goods and/or services by passing their unique identification (ID) across readers located throughout the venue. By way of example, when entering an amusement park, a family or individual purchases a ticket and also has the opportunity to procure RFID wristbands. The wristband will have a unique RFID (for example) and enables the user/holder of the wristband to use it as a virtual credit card at the amusement park. The wristbands also enable both tracking position and monitoring uses throughout the venue. These wristbands may be venue specific or may be able to be used and/or tied to two or more venues.

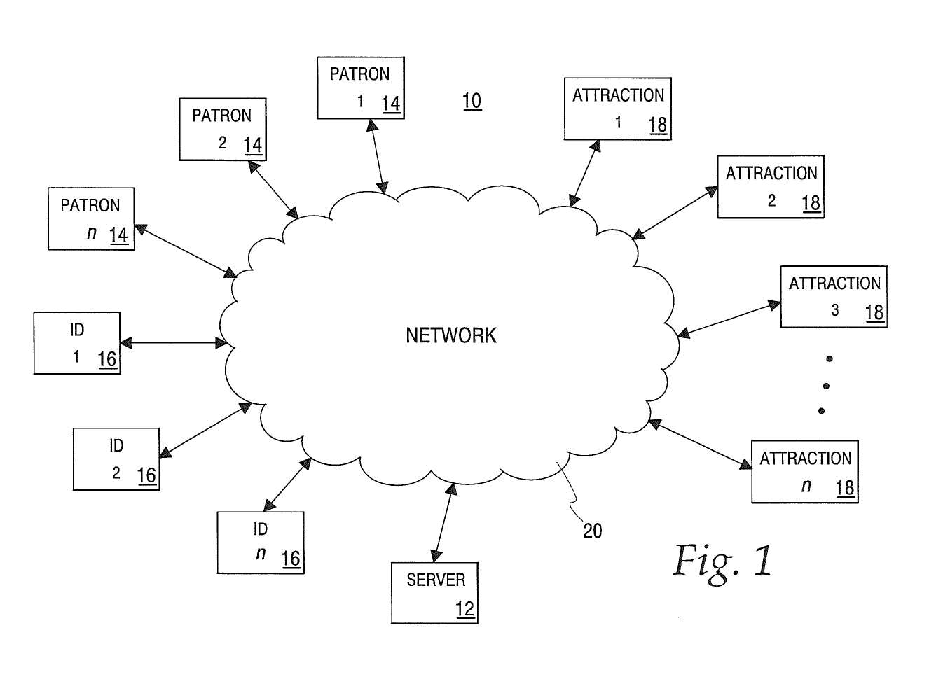

FIG. 1 is a schematic overview diagram of the communication network and computing environment in which the preferred embodiments are implemented. The preferred queue management system 10 includes one or more servers 12, patron personal communication devices (“PCDs”) 14, user ID units 16 and attraction PCDs 18, linked together using a network 20, such as the internet. The network 20 may be comprised of any network known in the art including TCP/IP based networks (e.g. the Internet, an Internet), LAN, Ethernet, WAN, Token Ring, etc. Alternatively, there may be separate and different networks between components. Further, because the preferred embodiment of the network 20 is the Internet, there can be a huge number of users, including patron (Patronₙ), user (IDₙ) and attraction (Attractionₙ) simultaneously.

The servers 12 include database and database interface known in the art. The server 12, through its database, keeps current, accurate information about the users of the service, e.g., patrons, users and venue attractions. Information is preferably stored in a non-volatile storage system, such as one or more hard disk drives, used by the server 12 for storage. The server may load data from the storage system into volatile memory when processing. It is envisioned that the management system 10 will utilize multiple servers 12 at different physical locations to help ensure safety and security. It is further envisioned that the management system 10 may utilize off-site remote server services, such as a dynamic virtual private server (e.g. cloud server). In any event, the server 12 may comprise one or more separate computer systems to run the different components of the queue management system 10. Accordingly, the server is capable of receiving and transmitting communications with the databases and otherwise.

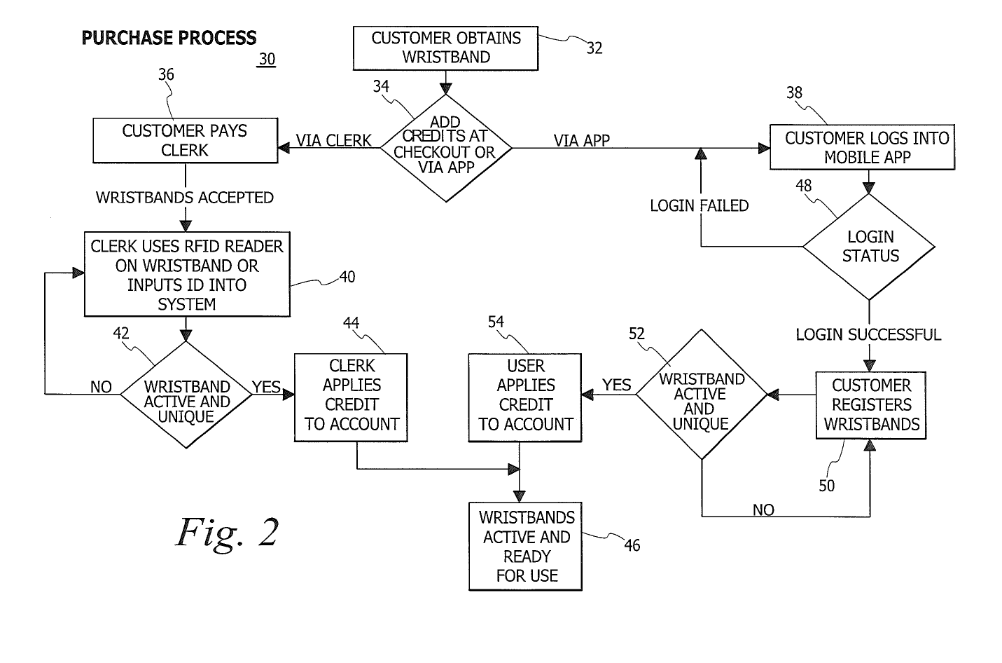

Before being able to use the management system 10, patrons will need to procure ID(s). Referring to FIG. 2, the ID procurement process is illustrated. When a patron enters the amusement park and obtains an RFID bracelet 32, he has a number of options 34 by which to credit the ID with funds. The patron can credit the ID through a clerk or kiosk 36 or the patron can credit the ID through a PCD 38 such as a smartphone or the like. If the patron goes to the clerk, the IDs are accepted and the clerk uses an RFID reader on the wristband or manually inputs 40 the ID into the system 10. The system then determines 42 whether the ID is active and unique. If not, it may be re-entered 40 or another wristband may be issued. Once the wristband is determined to be active and unique, the clerk applies the appropriate amount of credit 44 to the ID, and the ID is then active and ready for use 46. If the patron would rather use custom kiosks, the process is similar. The patron is presented with a touch screen at a custom kiosk located throughout the park that provides instructions on how to purchase an ID. The patron can directly add funds to the associated ID with a credit card and links the ID straight to his account. After the transaction is complete, the kiosk encodes the ID and dispenses it to the patron. If the patron would rather use a PCD to apply funds, he first must log onto the mobile queue management system application 38. Login status is determined 48, and once successful, the patron registers the ID(s) 50. The system then determines 52 whether the ID is active and unique. If not, it may be re-entered 50. Once the wristband is determined to be active and unique, the patron applies the appropriate amount of credit 54 to the ID, and the ID is then active and ready for use 46. It will be understood that whether the patron decides to activate their associated ID through a clerk or through a PCD, there can be multiple associated IDs with each patron.

The patron PCD will have a login and a password, and will have the ability to record and associate as many as thirty-five (or more) RFID bracelets which the patron will be able to identify the last known location and the time of each use of each programmed RFID bracelet that they wish to track. Long range readers located throughout the venue will be able to capture RFID location up to no less than twenty feet from a reader as the RFID holder passes that particular location. The more locations the venue has readers, the more accurate the tracking of each RFID holder. From the PCD, the patron will be able to log a credit card, or place money on an account that they will be able to designate to a specific RFID bracelet. This money (credit) on the bracelet will be able to be used at multiple locations throughout the venue such as ZOOMLINE® queue service enabled attractions, concession stands, gift shops, and the like. The RFID holder merely needs to place their bracelet two inches from the reader at any location for any deduction to take place from the bracelet.

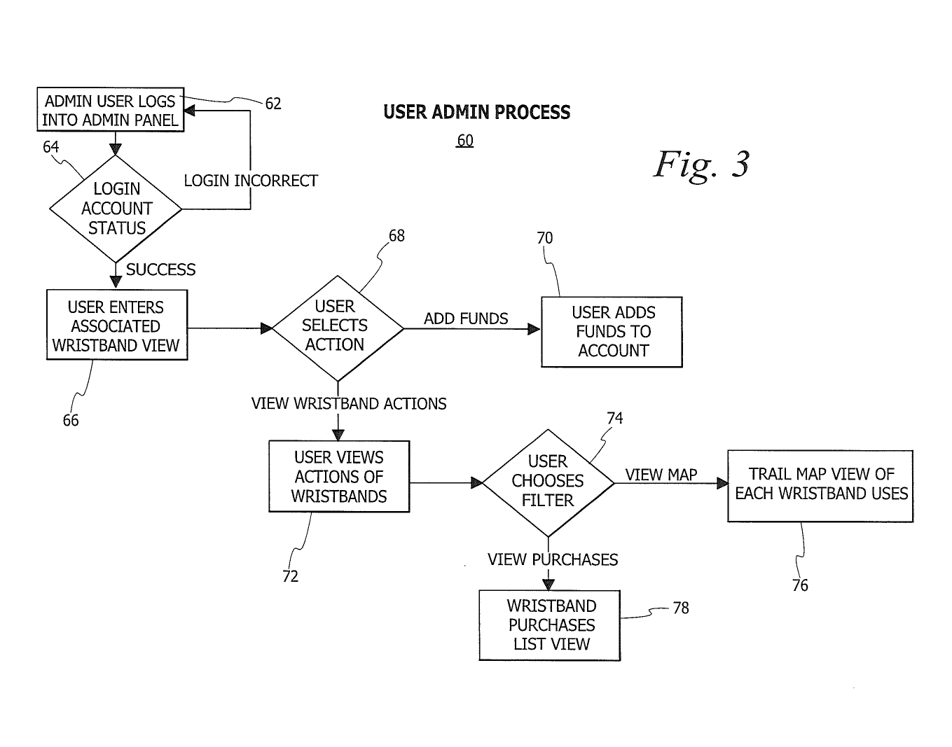

Once wristbands have been activated and are ready to use, the patron has the ability to add more funds and/or perform other options. Referring now to FIG. 3 and the patron administration process 60, the patron can access the system by logging into their account 62 via a venue kiosk or their PCD. In any event, log in status is determined 64, and once successful, the patron enters the associated view 66 and selects 68 the appropriate action. For example, the patron can add more funds 70 or view other actions 72. If he chooses filters 74, there will be numerous options to choose from, such as view each associated ID via uses on a venue map 76, or view via a purchase listing 78.

Turning now to the particulars of the patron, user and venue uses of the waiting line transaction management system, a number of representative examples will be shown and described. The following figures will illustrate such uses through the use of so-called smartphones. However, as previously discussed, it will be understood that use of the disclosed system is not limited to smartphones or any other particular personal communication device (“PCD”).

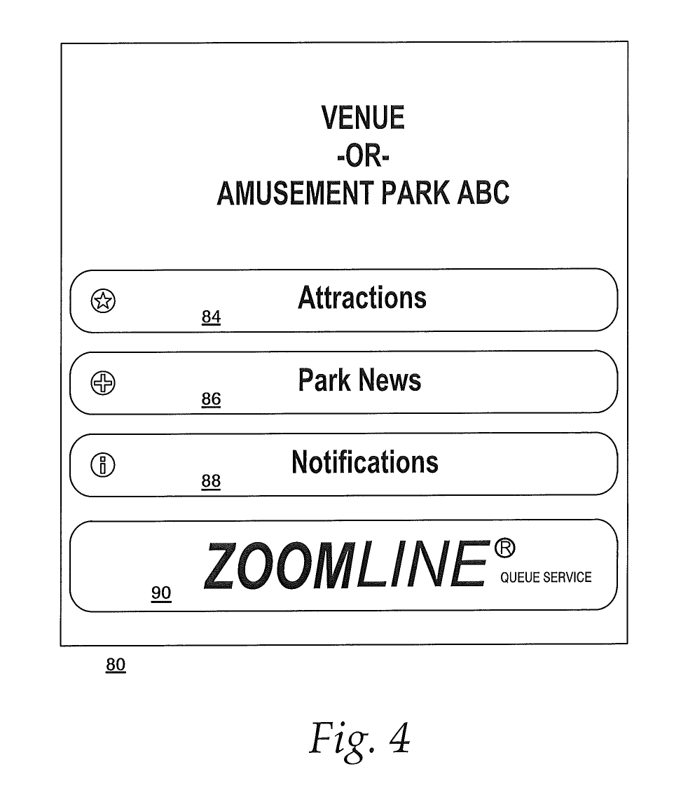

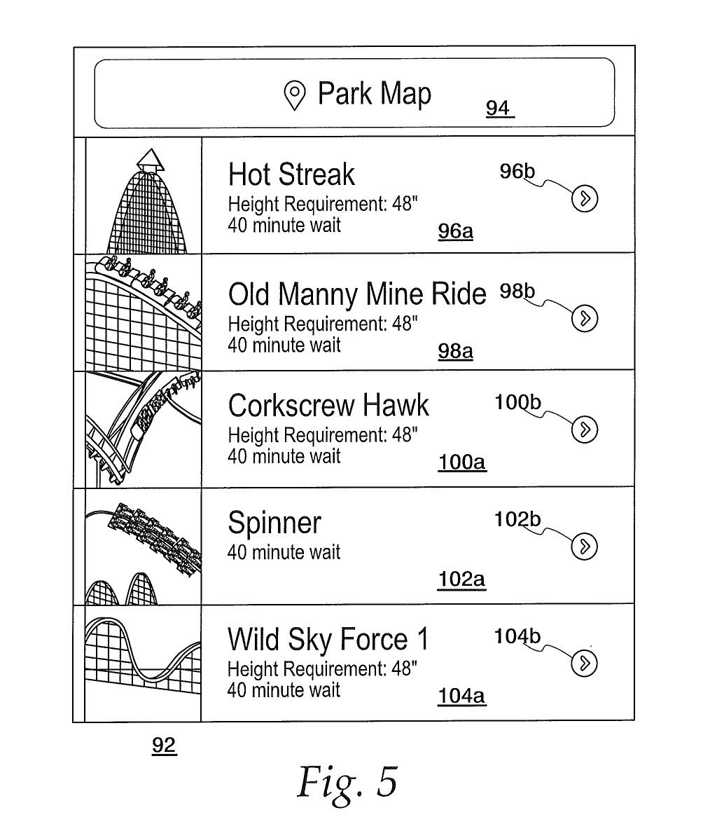

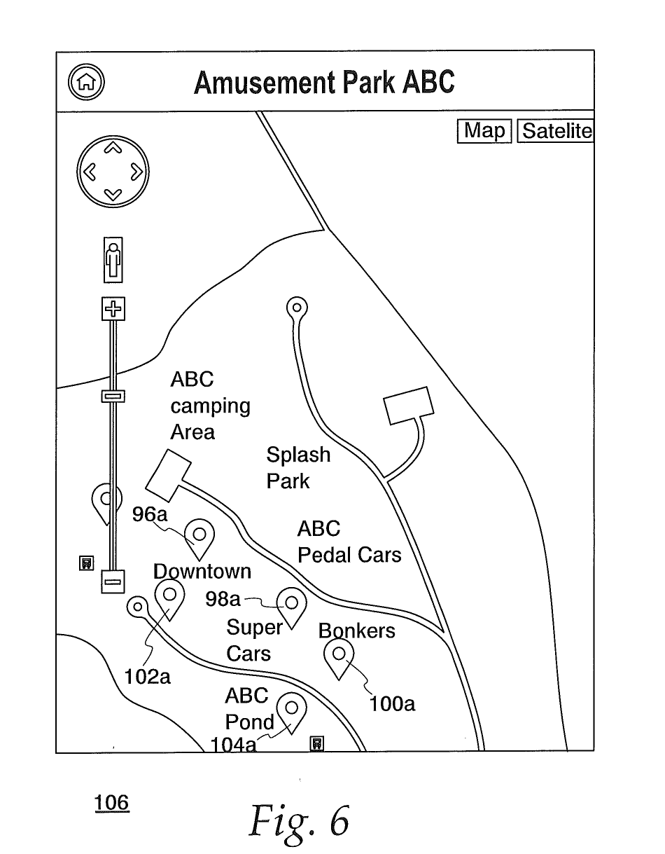

Turning now to FIG. 4 and the patron PCD home screen upon login. This home screen 80 could be venue specific, but will typically include options allowing the patron to choose between Attractions 84, Park news 86, Notifications 88 and ZOOMLINE® queue services 90. Selecting the Attractions icon will provide the patron with a listing of park attraction screen 92, see FIG. 5. This attractions screen 92 will typically include options allowing the patron to choose an interactive park map view 94 or specific attractions. The listed attractions (96a, 98a, 100a, 102a, 104a) may include attraction detail as well as a prompt (96b, 98b, 100b, 102b, 104b) to obtain further attraction detail. Should the patron select the park map 94, then the venue map screen 106 is presented, see FIG. 6. This interactive map screen 106 may provide the patron with the ability to once again choose from a number of park attractions (96a, 98a, 100a, 102a, 104a) for which to obtain further information.

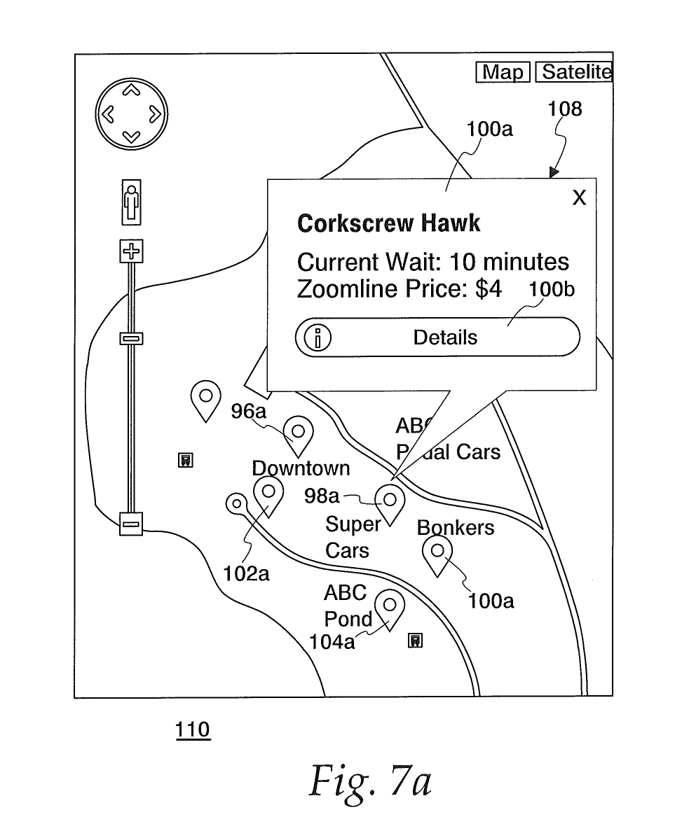

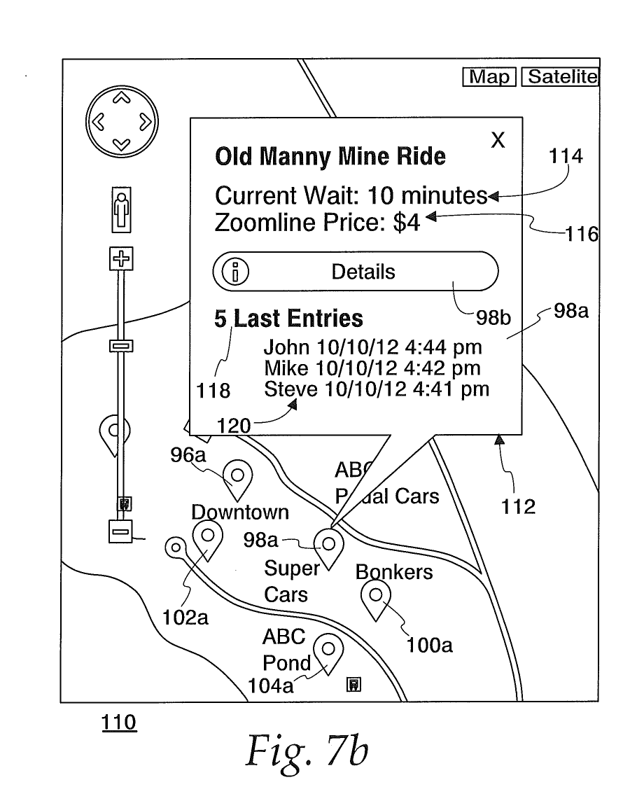

If an attraction is selected, for example Corkscrew Hawk Roller Coaster 100a, information related to that attraction may be presented in the form of a pop up window 108, see pop up window screen shot 110 of FIG. 7a. This pop up may further include the further attraction detail prompt (i.e. 100b). FIG. 7b illustrates the same pop up window screen shot 110, but includes a different attraction pop up window 112, and in particular that for Old Manny Mine Ride 98a. Similar to pop up window 108, pop up window 112 presents information related to that particular selected attraction. Information such as current wait time 114 for the attraction queue as well as the current price 116 for the user to skip the waiting line and proceed directly to the attraction. Additionally, further information such as the five last ID user entries 118 may be displayed together with a listing 120 of those users. Finally, the patron has the additional opportunity to obtain even further attraction details via selecting the Details prompt 98b.

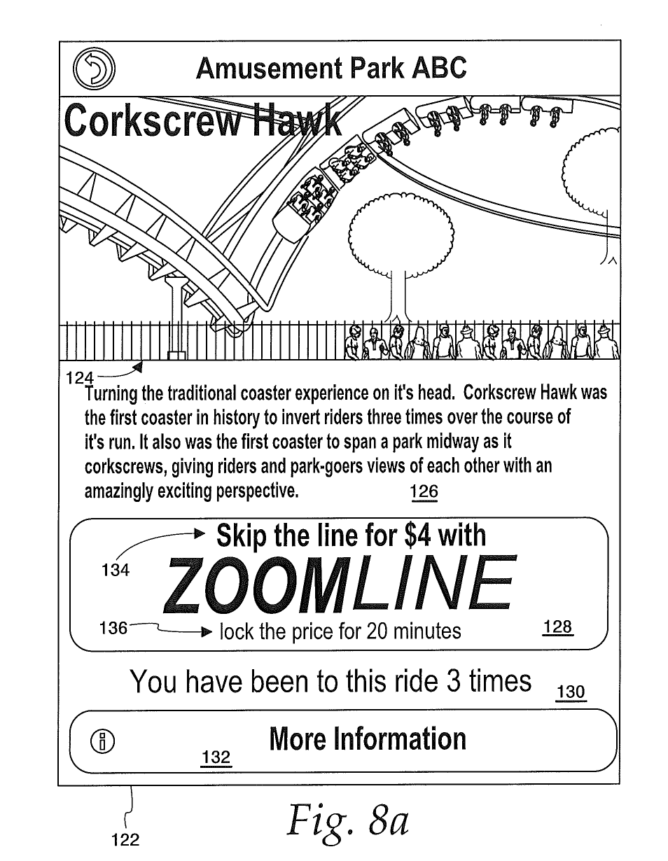

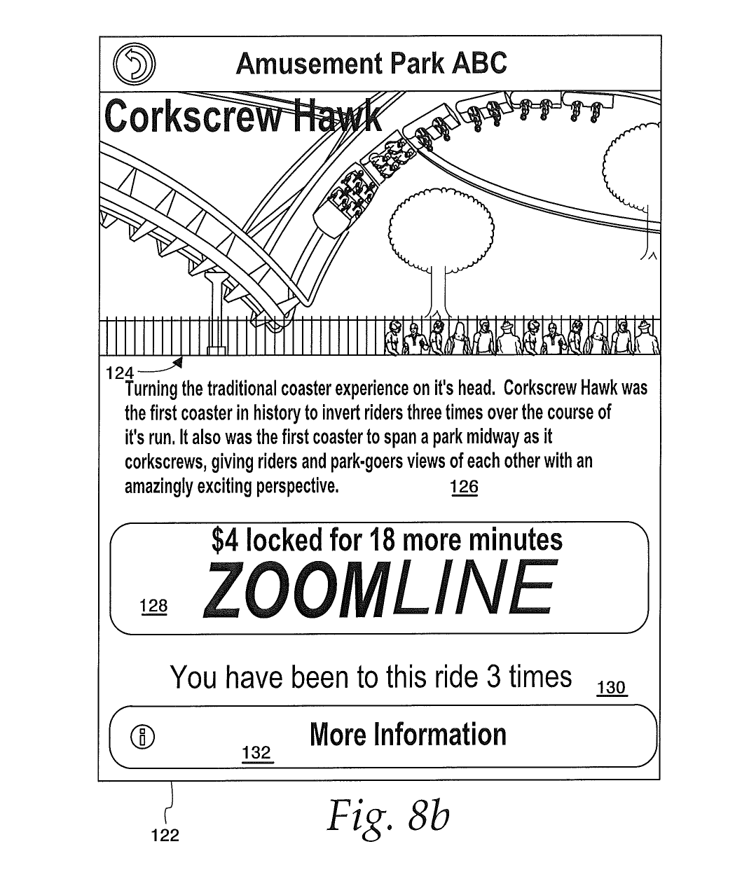

Should the patron select one of the further attraction detail prompts (i.e. 96b, 98b, 100b, 102b, 104b) he will be presented with a further attraction detail screen 122, see FIG. 8a. This screen 122 may include a photo 124 or perhaps a flash video or the like of the attraction, and some additional information 126 about the attraction. More specific details regarding the attraction might include the ZOOMLINE® queue service option 128, patron information 130 regarding the attraction and an even further informational prompt 132. The ZOOMLINE® queue service prompt 128 may include the current real-time price 134 to skip the waiting line, as well as a time 136 by which that price may be locked/held. FIG. 8b illustrates the further attraction detail screen 122 of FIG. 8a with the ZOOMLINE® queue service option 128 selected. In particular, the patron having locked in 138 the price by which a user(s) may skip the attraction waiting line.

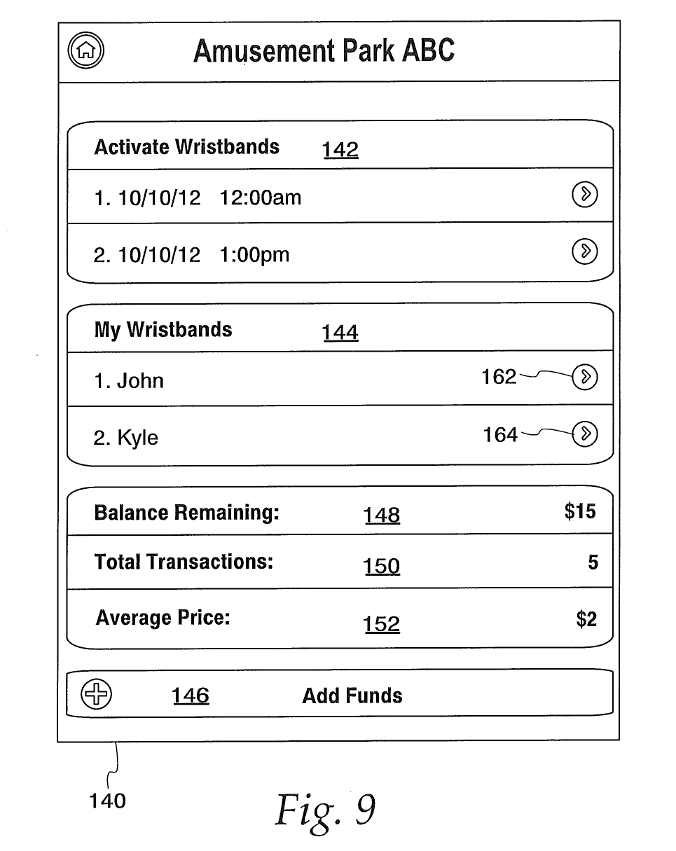

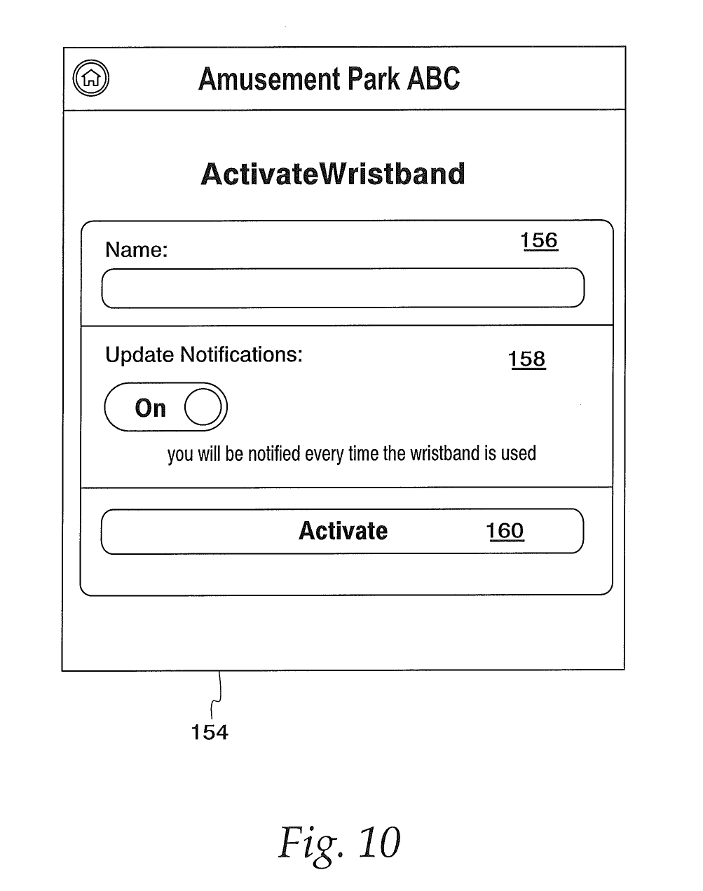

Referring back to FIG. 4, if the patron selects the ZOOMLINE® queue service option 90, then he will be presented with a patron administration screen 140, see FIG. 9. From this screen 140 the patron has numerous options, including activating wristbands 142, viewing wristband(s) 144 or adding funds 146. This administration screen 140 may further include other patron information, such as, for example, balance remaining 148, total transactions 150 and average price per transaction 152. Wristband activation 142 brings the patron to the patron ID activation screen 154, see FIG. 10. From this activation screen 154, the patron can, among other things, create a user name 156, determine whether he wants to be notified 158 with every user ID use and can choose to activate 160 each particular ID.

When accessing wristband information from a PCD, the patron must first attach the unique ID, or an identification code, to their account. This is done by either typing in the unique identification number or by passing the ID under a reader (for example). Once the RFID is linked the patron can add funds, or other negotiable credits, using a credit card (for example) or view where the ID holder has been through a GPS (or other positioning means) via the wristband. Parents or groups can link multiple wristbands to their account making it simple to keep track of children or group members. If an account has multiple linked wristbands, then the patron can view a map of the purchases with associated times that each wristband was used, together with overall financial statistics.

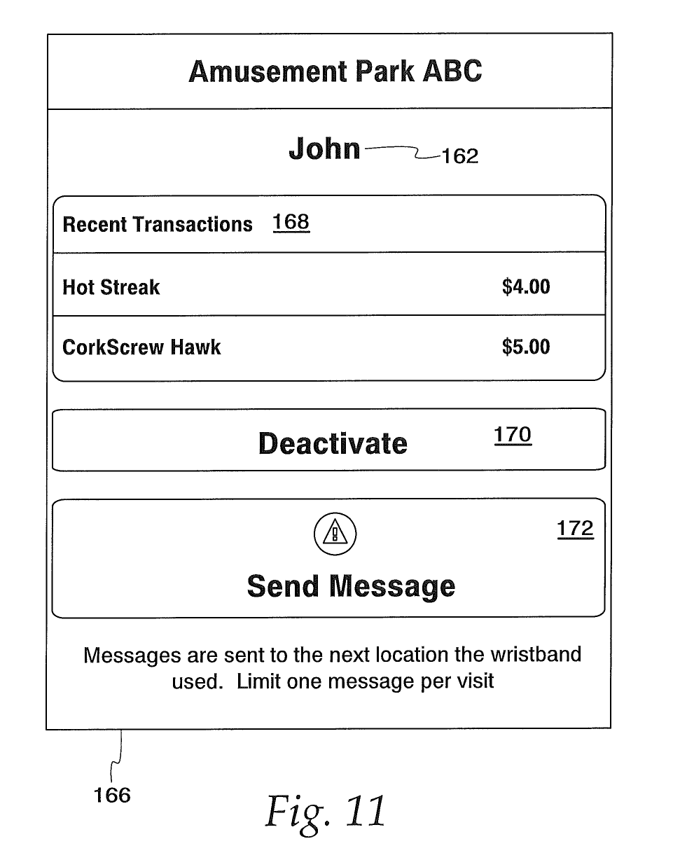

Within the viewing wristband 144 option of the administration screen 140, the patron can choose a particular ID for further viewing. For example, John's and Kyle's wristbands may be viewed by selecting their respective prompts 162, 164. FIG. 11 illustrates a particular ID detail screen 166; in this example John's 162 wristband detail is selected. The detail may include, among other things, recent transactions 168 and the ability to deactivate 170 the ID and perhaps send a message to the ID holder. If the patron wants/needs to send a message, such a message will be displayed at the next reader the user of the ID activates. The number of such messages could be limitless, numbered and/or could be charged to the patron account, depending on the desires of the venue.

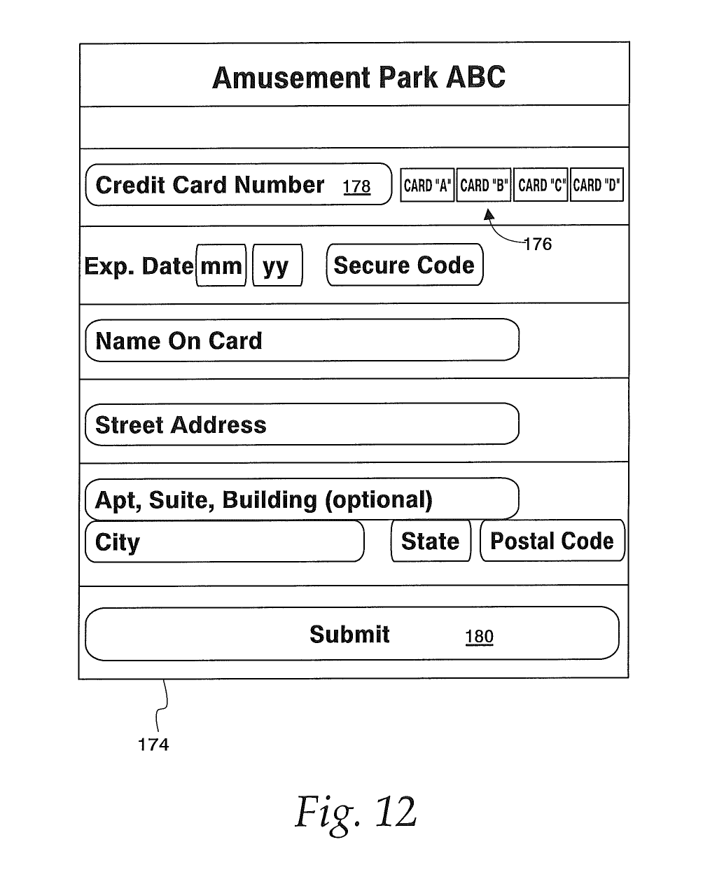

FIG. 12 illustrates the patron crediting of an ID screen 174. This is activated via the add funds options 146 on the patron administration screen. This crediting screen 174 enables the patron to charge/credit/deposit the appropriate funds to the respective ID. The patron can select what type of credit card 176, for example, then inputs the number 178 and any other typically required information and then submits 180 it to the system 10. The particular venue may also be capable of allowing the crediting of non-refundable points in lieu of monetary credits.

When inside the venue the ID holders can use their RFID wristbands (for example) at any attraction (or location) set up with a reader. These readers consist of, for example, a scanning pad and a small LCD screen with internet connectivity or a specified PCD. The LCD screen will display the cost of the ZOOMLINE® queue service pass and if it is currently active. If the pass is active, the ID holder can scan their RFID wristband, and then a request is sent to the system servers to check if the associated account, via its identification code for example, is active and has sufficient funds, and/or negotiable credits, available. If the account is clear, the payment is charged and the transaction recorded. A response is then sent back to the scanner, if successful, the LCD will display the current balance and “approve” the ID holder and he can pass the waiting line. The ID holder essentially has purchased a priority pass to gain access to the attraction. If there was an error or insufficient funds in the account, the display will deny entry and display the reason.

These wristbands will stay active until funds are depleted or use/transaction success is canceled by the patron via the system website or through the patron PCD. If a bracelet is lost, the system is capable of shutting off transaction capabilities and removing remaining credit (whether in the form of monetary credit, negotiable credit, reward points, or otherwise) from the bracelet. The patron can reactivate at any time and all transaction information will remain available.

Some additional features of the system 10 include the capability of being able to lock into a posted price from the venue and assign it to a specific RFID bracelet, of which the ID holder would then have to appear at the location within 20 minutes (for example) to take advantage of the specific posted price. This would give the venue the ability to control traffic patterns within the venue, as well as entice people to certain areas for any particular reason. Screens throughout the venue will be available to post values and wait times on a constant basis for people who do not want to carry around a PCD with them in the park.

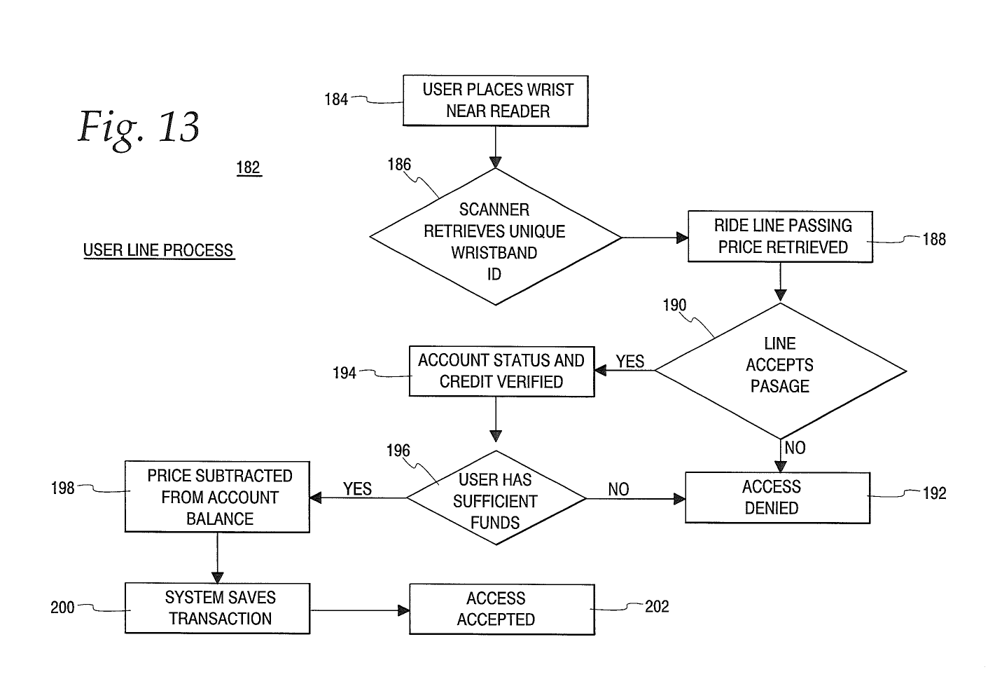

Once the patron has activated an ID, it is ready to be used at a venue attraction and/or to purchase goods and/or services within the venue. FIG. 13 illustrates an ID flow diagram for use at an attraction utilizing the waiting line transaction management system of the present disclosure. In particular, the flow diagram describes the user line process 182 enabling the ID (i.e. RFID wristband) holder to by-pass the normal waiting line and gain immediate access to the attraction. By way of example, user approaches Roller Coaster ABC and finds that there is a two (2) hour wait. However, Roller Coaster ABC also accepts the ZOOMLINE® queue service, and for $7.00, the user can skip the wait and immediately ride the coaster. In order to gain access, the user places his ID near the Roller Coaster ABC reader 184 and the reader retrieves 186 the unique (wristband) ID code, the attraction price is retrieved 188 and determines whether the attraction is still currently accepting 190 a pass. If the attraction is not accepting passes, access is denied 192. If the attraction is accepting passes, the user account status and credit, or indicia indicating a number of negotiable credits associated with the ID code, is verified 194 and it is determined whether the ID has sufficient funds 196 to gain access. If the ID does not have the sufficient amount of funds, access is denied 192. If the ID does have sufficient funds, the price of the pass is subtracted 198 from the ID account balance, the system 10 saves the transaction 200 and access to the attraction is accepted 202.

The venue administrator can regulate the price they set for skipping the normal waiting line of all their attractions in near real time from the system website or a PCD. After the administrator logs into the administration panel, they have the option of viewing each scanner/reader on a map of their park or from a list. After selecting an attraction the administrator can view sales statistics in a set of time increments or change the price for a pass. Once the price is changed in the administration panel, the price will change in near real time on the attraction scanner/reader. The venue administrators can also view overall financial and usage statistics from the administration panel.

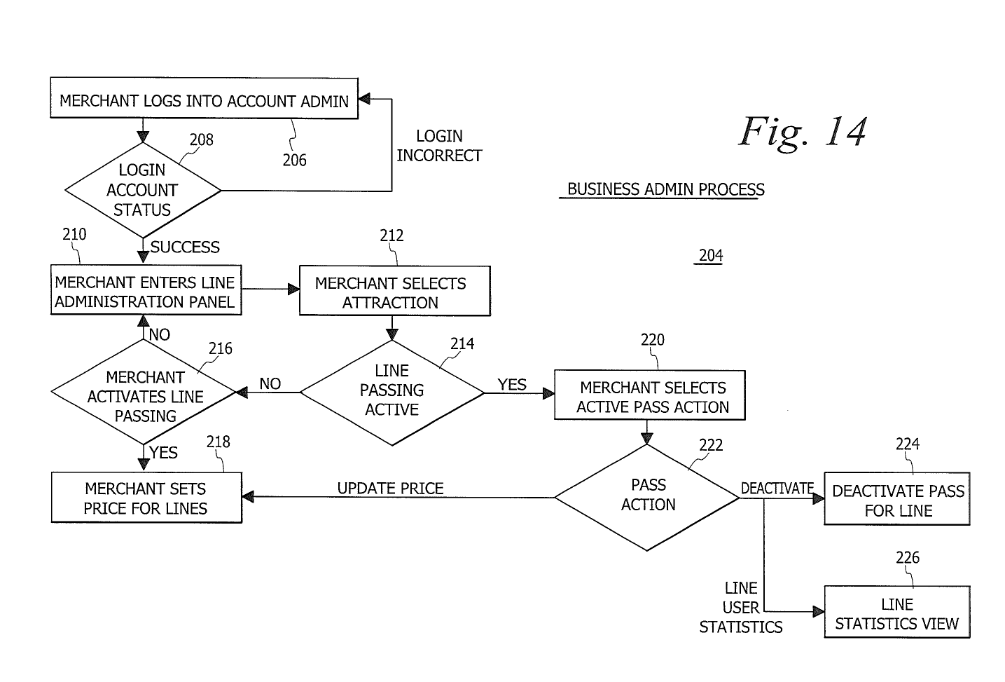

The amusement park (venue) business administration will now be described as it relates to attraction line pass price setting and other features. Referring first to FIG. 14, a business administration process flow diagram 204 for use of the waiting line transaction management system of the present disclosure is illustrated. The merchant or business administrator logs into the account administration 206, the login account status is determined 208 and upon successful login, the merchant enters the line administration panel 210. From the line administration panel 210, the merchant can select the attraction 212. Upon attraction selection 212 it is determined whether attraction line passing is currently active 214. If line passing is not active then the merchant can activate 216 and then set the price 218 in near real time. If line passing is active, the merchant can select 220 an active pass active 222 such as, for example, update the price 218, deactivate pass 224 for the attraction or view line statistics 226.

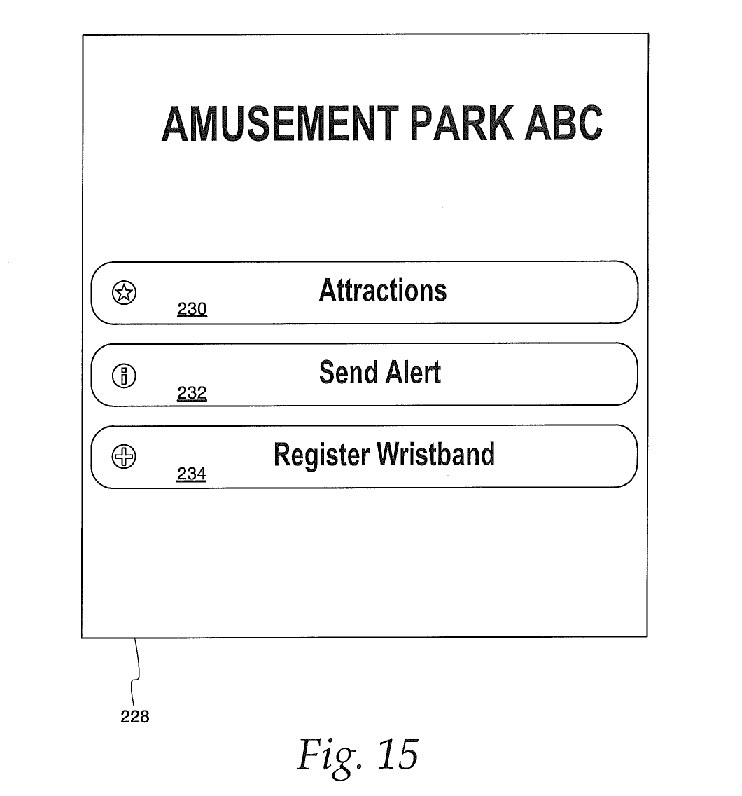

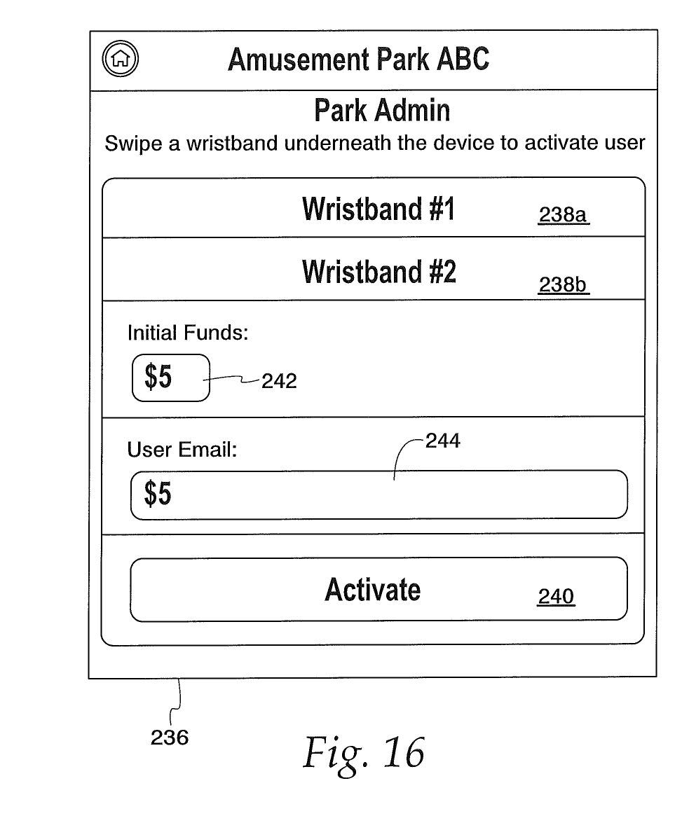

The merchant can access the business administration through numerous options, including a computer, a venue kiosk or a venue PCD. In any event, FIG. 15 illustrates a PCD screen shot 228 upon log in. From this screen 228 the park administrator can select, for example, an attraction 230, send an alert 232, and register an ID 234. If the administrator chooses to register a wristband (234) he is directed to the park administration ID activation screen 236, see FIG. 16. More particularly, the administrator swipes the user IDs under an associated reader/scanner and the wristbands are displayed 238a and 238b and ready for activation 240. This screen may further include other information, such as, for example, initial funds 242 and user email address 244.

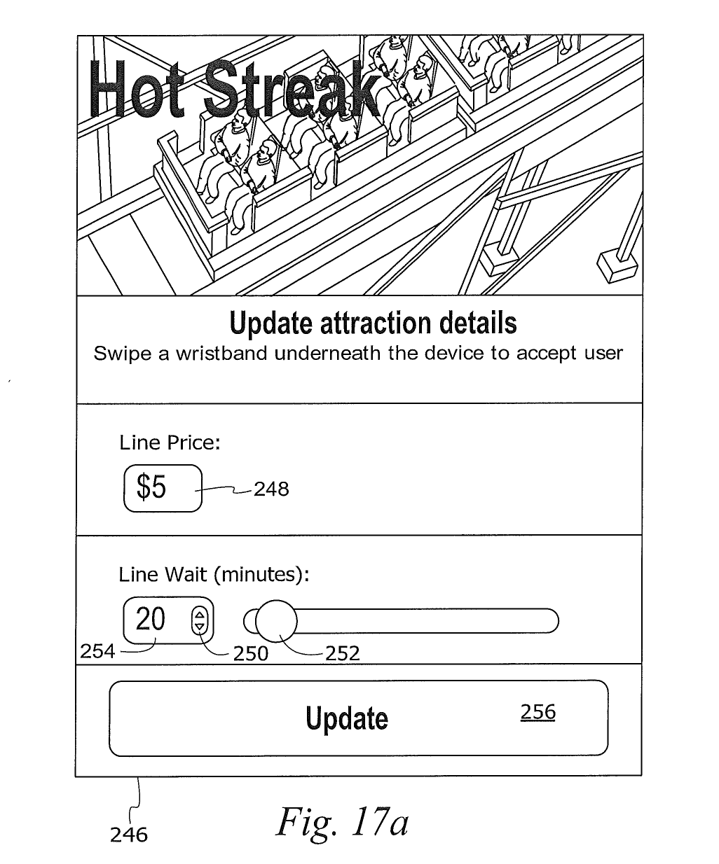

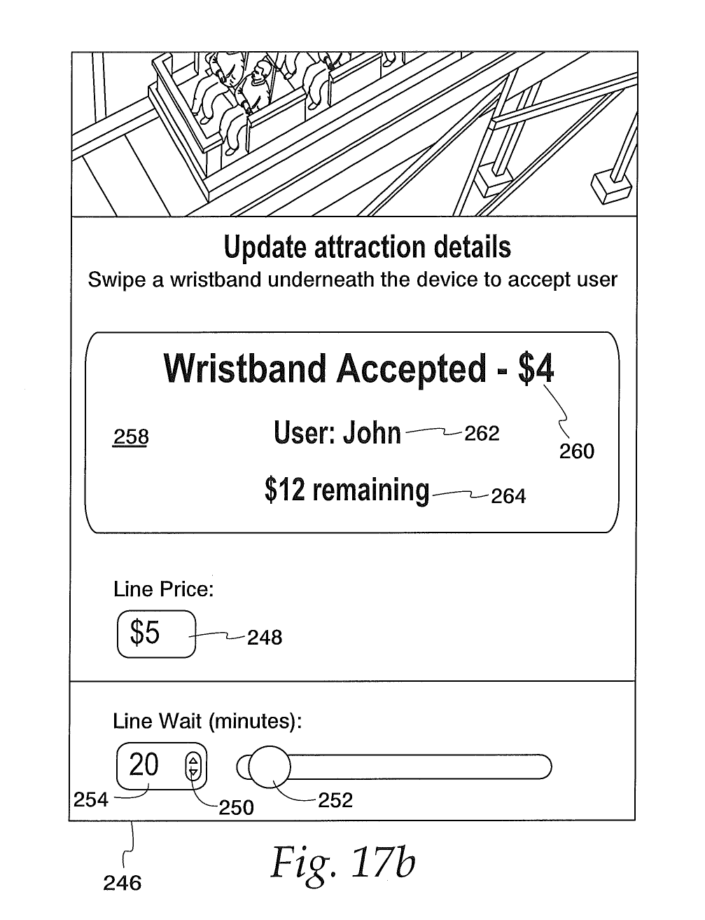

If the administrator selects an attraction from the login screen 228 of FIG. 15, that particular attraction, for example, the Hot Streak roller coaster screen 246 is presented, see FIG. 17a. From the attraction screen 246, the administrator can both view and update the attraction details. The price 248 for skipping the line can either be set manually or automatically through the system algorithm. Such an algorithm may consist of attendance in the venue, and wait time per attraction. By way of example, the increase/decrease counter 250 and/or the sliding toolbar 252 adjusts the length of the line wait 254 and depending upon the system 10 algorithm, may automatically set an appropriate price 248. In any event, once the price is set it can be updated via the price update selector 256. Additional information may be included in the attraction screen 246, see for example, attraction detail 258 of FIG. 17b. Such detail may include the last price 260 for ID acceptance, the last ID user 262 and the amount of credit remaining 264 for the user.

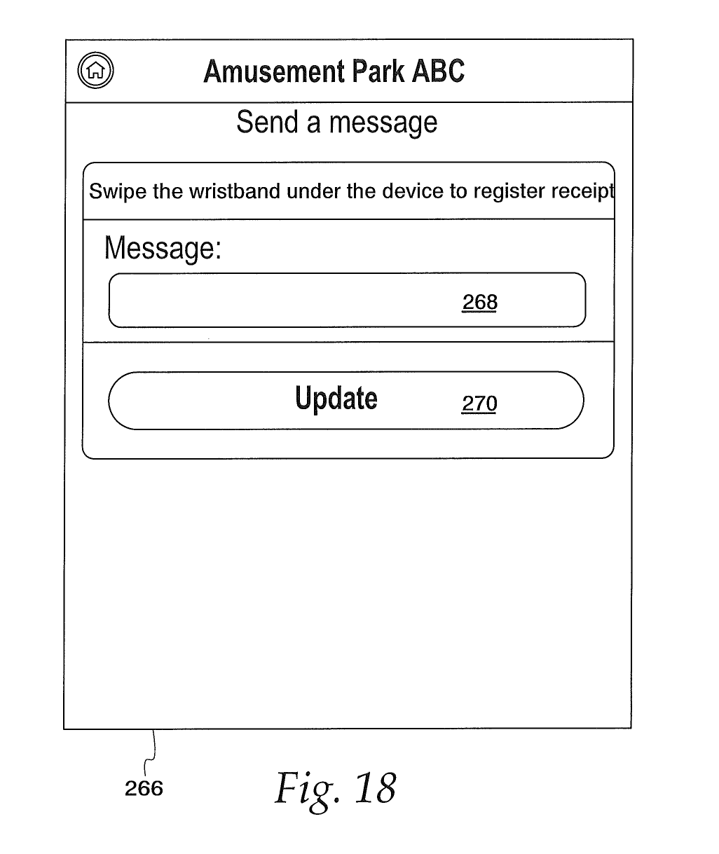

Finally, the administrator may have selected the send alert 232 option from the login screen 228 of FIG. 15, and accordingly will be directed to the send message screen 266 of FIG. 18. From here, the administrator can enter a message 268 and update 270. The communication capability of the system allows for messages to be sent via PCD or otherwise and received on the scanner/reader when that particular ID is scanned.

It will be appreciated that a venue account coordinator and/or system host can be a third party and that the account coordinator or system host can receive compensation for acting as the account coordinator or system host. For example, a third party account coordinator or system host can receive a percentage of the priority pass fees, per scan/read fees, other fees and/or can, for example, be permitted to display advertisements in association with any of the interactive screens and thereby derive revenue from acting as an account coordinator or system host. It will further be appreciated that such compensation can be automated so that the account coordinator or system host is automatically compensated upon a fee transaction. Additionally, the compensation system can be configured to provide for alternate formulas for compensating the system host, account coordinator, merchant and/or venue owner. The system can also be configured to reward the user by providing for frequent user discounts and or reward points.

As previously mentioned, the venue may be a ski resort. In that regard, an RFID bracelet would fit over the skiers glove and the ID holder could use it for bypassing the line at the lift, and enter through the singles line for a premium set by the algorithm established based on wait time. The IDs could be used to track last known location by having readers/antennas at the top and bottom of each lift. As the ID holder passes the antenna, patrons and friends could locate the RFID tag if loaded into their respective PCD. The RFID bracelet could further be used as a debit card in the ski lodge in lieu of cash.

A venue might be a school trip destination or field trip. The system would then be able to load money into school children's RFID bracelets and track their location.

The venue might be a sponsored event package for individuals or groups. Exemplars of such include, but are not limited to: spring break vacations, vacations, parties, concerts, sports, games, social gathering and others. If a spring break package, for example, the venue may include multiple merchants each capable of employing the current system with respect to a sponsored event package.

The RFID bracelets allow the merchants, venue administrators and system administrator the ability to capture all data provided by the patron and their ID users, including, but not limited to name, DOB, address, phone, email, social media connections, gender, race, pictures, etc. All information may be capable of being stored on a secure server and/or may be cloud based. Merchants can use some of this information for individual venue data gathering, real time price adjustment, activation/deactivation of readers and scanners, push notifications, real time statistics on users and (spending) trends set by users, for example.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. An attraction waiting line management system for use with personal identification units having monetary credit associated therewith and a network comprising:
a first queue whereby users access an attraction by waiting in line;
a second queue whereby users bypass said first queue to gain access to said attraction;
a venue communication device establishing a price, through said network, for a user to purchase a pass for access to said second queue; and
an identification unit reader deducting said price from the credit of said unit and permitting access to said attraction by the holder of said unit.

2. An attraction waiting line management system as defined in claim 1 wherein said network is the internet.

3. An attraction waiting line management system as defined in claim 1 wherein said personal identification unit is an RFID bracelet.

4. An automated system for managing waiting time at an attraction for use with personal identification units having monetary credit associated therewith and a network comprising:
a venue communication device communicating with said system, through said network, for establishing a price for a user to purchase a pass for priority access to said attraction; and
an identification unit reader deducting said price from the credit of said unit and permitting priority access to said attraction by the holder of said unit.

5. An automated system as defined by claim 4 wherein said network is the internet.

6. An automated system as defined by claim 4 wherein said identification unit is an RFID bracelet.

7. An automated system for managing waiting time at an attraction within a venue for use with personal identification units having monetary credit associated therewith and a network comprising:
a server capable of receiving and transmitting communications;
a personal identification database containing information representing each of a plurality of personal identification units, said personal identification unit database in communication with said server;
an attractions database containing information representing one or more attractions within a venue offering priority access for a fee, said attractions database in communication with said server;
said server capable of communicating with a venue communication device receiving fee information for priority access to said attraction and for transmitting information to said attraction concerning a price for said priority access; and
an identification unit reader at each of said attractions within the venue deducting said price from said credit of said unit and permitting priority access to said attraction by the holder of said unit.

8. The system of claim 7 wherein said identification unit is an RFID bracelet.

9. The system of claim 7 wherein said personal identification unit database comprises unique identification information for users within the database.

10. A venue waiting line management system for use with one or more attractions within the venue and venue specific personal identification units having monetary credit associated therewith and a network comprising:
a first queue whereby patrons access an attraction by waiting in line;
a second queue whereby patrons bypass said first queue to gain access to said attraction;
a venue communication device for establishing a price, through said network, for a patron to purchase a pass for access to said second queue; and
an attraction identification unit reader for deducting said price from said credit of said personal identification unit and permitting access to said second queue by the personal identification unit holder.

11. An admission management system comprising:
an attraction;
a first queue whereby users access said attraction by waiting in line;
a second queue whereby users bypass said first queue to gain access to said attraction;
a personal identification unit, said unit including an identification code and said unit further including an indicia of a number of negotiable credits associated with said identification code;
a personal identification unit reader capable of recognizing said personal identification code and the negotiable credits associated with such code, said reader also capable of effecting a modification of the number of credits associated with such code;
an attraction communication device capable of communicating with said reader and transmitting to said reader information establishing a number of negotiable credits for access to said second queue;
whereby said reader and said personal identification unit are configured to allow access to said second queue by subtracting the number of negotiable credits for accessing said second queue from the number of negotiable credits associated with the personal identification code for said personal identification unit.

12. The management system of claim 11 wherein the attraction is an amusement park attraction.

13. The management system of claim 11 wherein the attraction is a restaurant.

14. The management system of claim 11 wherein the attraction is a concert.

15. The management system of claim 11 wherein the attraction is a sporting event.

16. The management system of claim 11 wherein the attraction is a ski lift.

17. The management system of claim 11 wherein the negotiable credits are monetary credits.

18. The management system of claim 11 wherein the negotiable credits are award points.

19. The management system of claim 11 wherein the personal identification unit is an RFID bracelet.

20. The management system of claim 11 wherein the system further comprises a personal communication device capable of communicating with the personal identification unit.

21. The management system of claim 20 wherein the personal communication device is capable of modifying the number of negotiable credits associated with said personal identification code.

22. The management system of claim 20 wherein the personal communication device is capable of monitoring the use of the negotiable credits associated with said personal identification code.

23. The management system of claim 20 wherein the personal communication device is capable of receiving information identifying the location of said personal identification unit.

24. The management system of claim 20 wherein the personal communication device is capable of transmitting messages associated with said personal identification code.

25. The management system of claim 11 wherein said reader is capable of displaying messages associated with said personal identification code.

26. The management system of claim 11 wherein said reader is capable of transmitting information related to said personal identification unit.
